(19) United States
(12) Patent Application Publication
(10) Pub. No.: US 2003/0084932 A1
(43) Pub. Date: May 8, 2003

(54) Bolt-type adjustable crutch

(76) Inventor: Kyungil-Cho, Goyang City (KR)

Correspondence Address: SHERIDAN ROSS PC, 1560 BROADWAY, SUITE 1200, DENVER, CO, 80202

(21) Appl. No.: 10/326,631

(22) Filed: Dec. 20, 2002

Related U.S. Application Data
(63) Continuation-in-part of application No. 10/212,970, filed on Aug. 5, 2002.
Application No. 10/212,970 is a continuation-in-part of application No. 09/390,665, filed on Sep. 7, 1999.

(30) Foreign Application Priority Data
Aug. 6, 2001 (KR) 01-0009691

(51) Int. Cl. A61H 3/02

(52) U.S. Cl. 135/68

(57) ABSTRACT

A medical crutch has adjustable features including a handle slidable between a pair of side bow tubes thereby enabling adjustment of the height of the handle. Extensions formed on the handle facilitate slidable movement as well as maintaining the handle between the pair of side bow tubes. Projections formed on the ends of the side bow tubes facilitate alignment of the handle so that a securing bolt can be inserted through the side bow tubes and handle. Another adjustable feature includes a lower globe which secures lower ends of the side bow tubes, and facilitates slidable movement of the lower middle tube between said pair of side bow tubes. The lower globe includes at least one projection which selectively engages openings formed on the lower middle tube also helping to register a continuous aperture between the side bow tubes and the lower middle tube which receives a securing bolt.

### CROSS REFERENCE TO RELATED APPLICATIONS

This application is a continuation-in-part of co-pending application Ser. No. 10/212,970, filed on Aug. 5, 2002 entitled “BOLT-TYPE ADJUSTABLE CRUTCH” which is a continuation-in-part of co-pending application Ser. No. 09/390,665, filed on Sep. 6, 1999 entitled “HEIGHT-ADJUSTING MEDICAL CRUTCH”; this application incorporating herein by reference in their entireties each of the applications listed in this cross reference.

### FIELD OF THE INVENTION

The present invention relates to a medical crutch. In particular, the present invention relates to a medical crutch having adjustable features to facilitate necessary height and handle adjustments.

### BACKGROUND OF THE INVENTION

Prior art adjustable crutches, such as the crutch 100 illustrated in FIG. 1, typically includes a pair of side bow tubes 102, a bottom middle tube 104, and one or more bolts 106 for securing the tubes together. The bolt(s) are inserted through openings in the side bow tubes 102 and an aligned opening 108 formed in the bottom middle tube 104. In order to adjust the height of the prior art crutch, the bottom middle tube is positioned at a desired height, then one must align the openings in the tubes, and finally the bolt 106 is inserted. Because there are three sets of holes which must be aligned, making a height adjustment to the crutch is unnecessarily difficult and inconvenient for the user.

Another example of a prior art medical crutch includes the U.S. Pat. No. 5,445,175. This reference also discloses an adjustable height crutch having a pair of side bow tubes and a bottom middle tube wherein height adjustment is achieved by manipulating the bottom middle tube.

Although the prior art may be adequate for its intended purposes, the present invention described below has certain advantages.

### SUMMARY OF THE INVENTION

In accordance with the present invention, an adjustable height medical crutch is provided of the type which utilizes bolts for securing the height adjustments. The invention has two adjustment features. The first feature is a handle which is grasped by the user, and can be vertically adjusted for optimal placement of the hands. The second adjustable feature adjusts the overall height of the crutch.

For the first adjustable feature, the handle is disposed between a pair of side bow tubes. The handle may be positioned at a desired height between the side bow tubes and secured as by a bolt which is inserted through transverse holes formed on the side bow tubes and an aperture formed through the length of the handle. Each corner of the handle includes an extension or flange which conforms to the exterior shape of the side bow tube which it contacts. The side bow tubes have substantially elliptical cross-sectional shapes wherein the inner surfaces of the side bow tubes are flat, and the flat inner surfaces transition to curved exterior sides of the side bow tubes. The extensions at each corner of the handle overlap both the flat inner surfaces and the curved exterior sides. These extensions help maintain the handle in its mounted position between the side bow tubes and also facilitate slidable movement of the handle up and down between the side bow tubes. The surface of the handle between the pair of extensions at each end of the handle may include a tab or projection which is alignable with the transverse holes in the side bow tubes. The tabs or projections are sized to minimally engage the holes thereby assisting in registering or aligning the handle so that a securing bolt may easily pass through the holes in the side bow and the aperture formed in the handle.

The second adjustable feature of the invention includes the use of a globe or keeper which secures the lower ends of the side bow tubes in a fixed relationship, and further allows for slidable movement of a lower middle tube therebetween. The globe includes an integral engagement mount having at least one projection or tab which extends substantially perpendicular to the extension of the lower middle tube. The projection or tab is sized to minimally engage the openings formed on the lower middle tube which receive the securing bolt. Depending upon the size and length of the projection, a preset amount of force is used to slide the lower middle tube to its desired position for height adjustment. The projection will provide some resistance to hold the lower middle tube within a corresponding hole in the lower middle tube thereby registering a continuous aperture above the projection allowing the securing bolt to then extend through the pair of side bow tubes and the lower middle tube. An upper globe or keeper is also provided to ensure there is aligned travel of the lower middle tube between the side bow tubes.

Additional advantages of the present invention will become readily apparent from the following discussion, particularly when taken together with the accompanying drawings.

### BRIEF DESCRIPTION OF THE DRAWINGS

FIG. 1 is an enlarged fragmentary perspective view of a prior art crutch;

FIG. 2 is a perspective view of the crutch of the present invention;

FIG. 3 is an enlarged horizontal section taken along lines 3-3 of FIG. 2 illustrating the first adjustable feature of the present invention;

FIG. 4 is an enlarged fragmentary exploded perspective view of the lower portion of the medical crutch specifically illustrating the second adjustable feature of the invention;

FIG. 5 is an enlarged fragmentary vertical section taken along line 5-5 of FIG. 4 further illustrating the second adjustable feature of the present invention;

FIG. 6 is a greatly enlarged area of FIG. 5;

FIG. 7 is an enlarged perspective view of the handle and an enlarged fragmentary view of one of the side bow tubes illustrating the tab or projection on the handle which facilitates easy height adjustment of the handle;

FIG. 8 is an enlarged horizontal section taken along line 8-8 of FIG. 7 illustrating the tabs or projections on the handle aligned with corresponding openings on the side bow tubes; and

FIG. 9 is a greatly enlarged fragmentary vertical section illustrating one projection of the handle aligned with an opening on the corresponding side bow tube.

### DETAILED DESCRIPTION OF THE DRAWINGS

An embodiment of the present invention will be described in detail in connection with the figures. The same reference numbers will be used throughout the various drawings to describe like components.

Referring first to FIG. 2, the adjustable crutch 10 of the present invention is shown. One primary component of the crutch includes a pair of side bow tubes 12 which extend side by side with one another. The upper ends of the side bow tubes 12 are interconnected by an armpit support 14. A lower middle tube 16 extends between the lower ends of the side bow tubes 12. The lower end of the lower middle tube 16 includes a standard bottom support 17, typically constructed of resilient rubber. The lower ends of the side bow tubes are secured in a fixed position as by a lower globe or lower keeper 18. The lower globe 20 also includes a center or middle opening for slidably receiving therethrough the lower middle tube. Optionally, an upper globe or keeper 20 is also provided to further stabilize the position of the side bow tubes 12. This upper globe 20 also includes a center opening for slidably receiving the upper portion of the lower middle tube 16.

The side bow tubes 12 and lower middle tube 16 may be advantageously constructed of a lightweight metal of adequate strength, such as aluminum. The globes 18 and 20 may be made of a high strength plastic material, or may be made of an adequate strength metal.

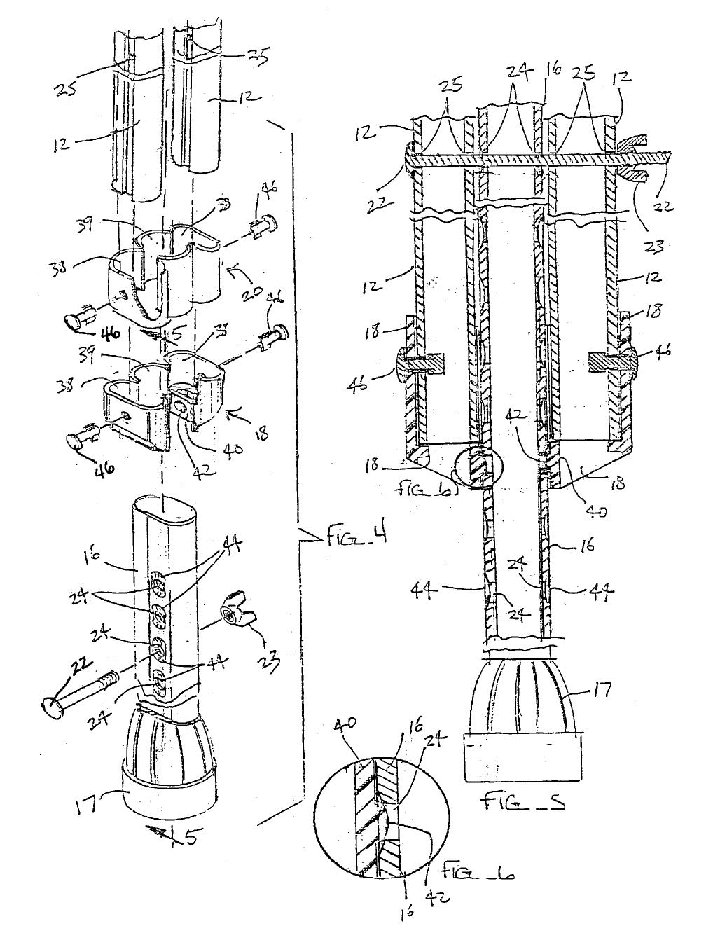

In order to adjust the overall height of the crutch, the lower middle tube 16 is slid between the pair of side bow tubes 12 and holes 24 formed on the lower middle tube are aligned with holes 25 formed on each of the side bow tubes. When the lower middle tube is placed in its desired position, a bolt 22 is inserted through the aligned openings, and the bolt is secured as by a wing nut 23. The aligned holes 24 and 25 can be collectively referred to as a continuous aperture. The use of the lower and upper globes help to ensure alignment of the side bow tubes with respect to the lower middle tube. However, a user must still exactly align the openings 24 and 25 in order to insert the bolt 22 therethrough. In order to further facilitate the ease by which the lower middle tube may be adjusted, means are provided on the lower globe 18 to register the holes 24 and 25. Now referring to FIG. 4, reference is made to an engagement mount 40 which is a structure formed on the interior of the globe 18. The cutaway section of this Figure shows the engagement mount 40 having a face with a projection or tab 42 extending therefrom in a direction substantially perpendicular to the extension of the lower middle tube 16.

Additional features of the construction of the lower middle tube are also shown in FIG. 4 wherein each of the holes 24 may also optionally include surrounding indentations or depressions 44. As also shown, the upper and lower globes are securely attached to the side bow tubes as by rivets 46. The upper and lower globes each have a pair of exterior openings 38 for receiving the side bow tubes, and a middle or interior opening 39 for receiving the lower middle tube.

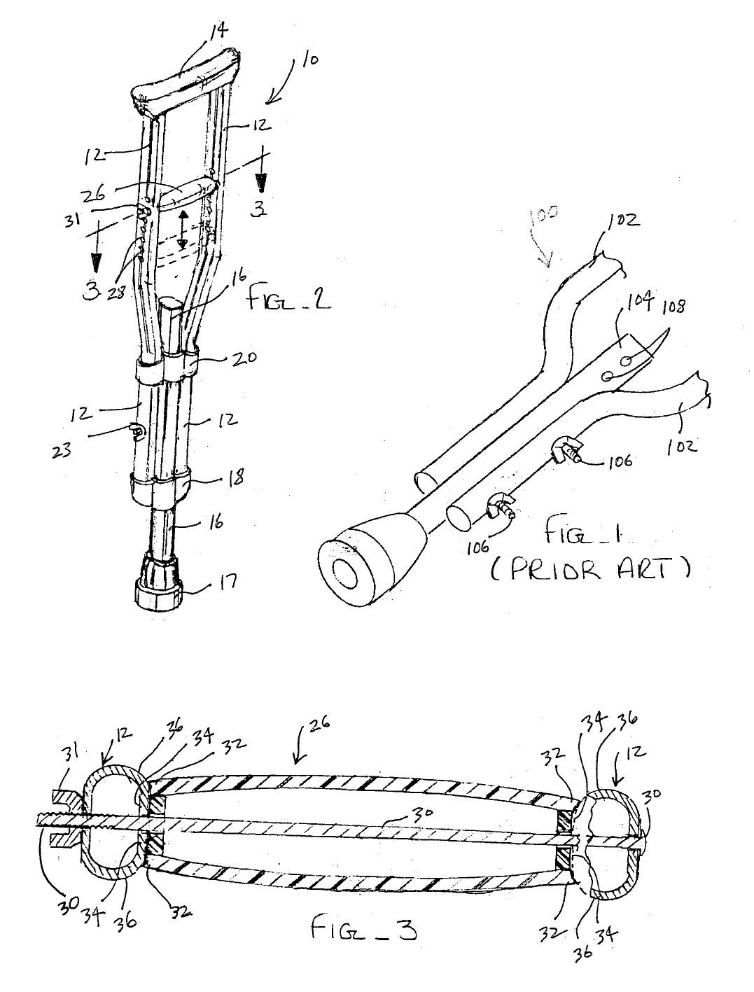

Now referring to FIG. 3, the first adjustable feature of the invention is shown in detail. Specifically, the handle 26 is shown extending between the pair of side bow tubes 12. A bolt 30 is used to secure the handle between the side bow tubes, the bolt having a threaded end for receiving a nut 31. In order to adjust the handle, the user would remove the bolt 30, and slide the handle 26 up or down until the handle was aligned with the desired pair of transverse holes 28 formed on the side bow tubes. Bolt 30 is then reinserted back through the openings 28 and the handle 26. In the cross-section of FIG. 3, it is seen that the handle has four corners defined by extensions 32 which conform to the exterior surface of the side bow tubes. More specifically, these extensions 32 have one end which contacts the flat inner edge 34 of the side bow tubes, and an opposite end which extends to some portion of the curved exterior surface 36. Thus, these extensions 32 help to prevent inadvertent removal of the handle between the side bow tubes because the extensions each capture or hold a non-linear surface of the side bow tubes.

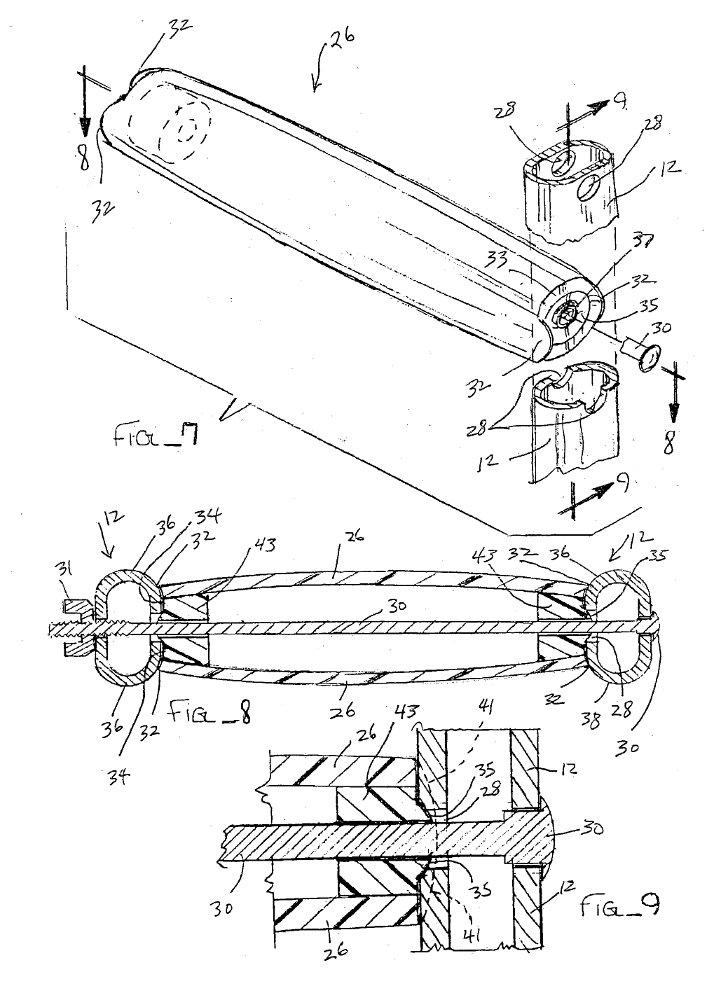

Referring to FIGS. 7-9, additional structural detail of the handle 26 is shown. Specifically, FIG. 7 is a perspective view showing one end of the handle 26 having an end surface 33 traversing between the pair of extensions 32. The tab or extension 35 may be formed on the end surface 33. The opening or aperture 37 extends through the projection 35. Referring to FIGS. 8 and 9, the handle 26 is shown in alignment with the pairs of transverse holes 28 formed on the side bow tubes. The projections 35 mate with the openings 28, and an indentation 41 (dotted lines) formed around the opening 28. The tab or projection 35 is sized so that it minimally engages the indentation 41 and transverse opening 28 thereby assisting the user in aligning the handle 26 with the transverse holes 28. The projections 35 are part of the end inserts 43 which close off the ends of the handles 26. The end inserts 43 can be integrally molded with the handles, or can be separate inserts. The combination of the extensions 32 along with the projection 35 not only helps to stabilize slidable movement of the handle 26 between the side bow tubes, but also helps to register or align the handle with the transverse holes 28. The projections 35 may be sized to adjust the amount of force necessary to slide the handle between the side bow tubes. A projection of greater size would make it more difficult to slide the handle. The handle 26 may include a projection 35 formed at each end of the handle, or the handle may only include one projection 35 formed at one end of the handle.

Now referring back to FIGS. 5 and 6, additional details of the second adjustable feature of the present invention are shown. Referring to FIG. 6, it is seen that the projection 42 may be received in a corresponding opening 24. By placing the projection 42 into one of the openings 24, another opening 24 above becomes automatically registered or aligned with the openings 25 of the side bow tubes thereby enabling easy insertion of the bolt 22 completely therethrough. FIG. 6 illustrates a pair of engagement mounts 40 and corresponding projections 42 formed within the globe 18; however, it shall be understood that only one mount and projection could be adequate to facilitate adjustment of this feature. As mentioned above, each opening 24 may have a surrounding indentation or recess. The indentations 44 facilitate movement of the projections 42 out of the openings 24 thereby reducing the amount of force which must be applied to slide the lower middle tube. The projections 42 themselves can be sized to adjust the amount of force necessary to slide the lower middle tube. A projection of greater size would make it more difficult to slide the lower middle tube. Additionally, holes 24 without corresponding indentations 44 would also make it more difficult to slide the lower middle tube.

By the foregoing, it is evident that a medical crutch is enhanced by the incorporation of a pair of adjustment features. Although both of these features are described with respect to the present invention, it shall be understood that a medical crutch is improved with only the incorporation of at least one of the features. These adjustable features are provided with relatively simple structural modifications, thereby minimizing the cost and complexity of the crutch.

What is claimed is:

1. An adjustable crutch comprising:
a pair of side bow tubes extending adjacent one another, said pair of side bow tubes each including an upper end and a lower end, and at least one opening formed through each of said side bow tubes adjacent said lower ends thereof;
a lower middle tube disposed between said lower ends of said pair of side bow tubes;
a lower globe for securing said lower ends of said side bow tubes and for slidably receiving said lower middle tube;
a handle disposed between said pair of side bow tubes adjacent said upper ends thereof; and
means integral with said lower globe for engaging one opening of a plurality of openings formed along said lower middle tube thereby registering a continuous aperture through said side bow tubes and said lower middle tube, said aperture defined by sets of aligned openings of said side bow tubes and said lower middle tube.

2. An apparatus, as claimed in claim 1, wherein:
said openings formed on said lower middle tube have depressions formed therearound thereby providing a transition between an exterior surface of the side bow tubes and the openings formed through the side bow tubes.

3. An apparatus, as claimed in claim 1, wherein:
said means for engaging includes at least one projection sized to engage one opening of said plurality of openings on said lower middle tube.

4. An apparatus, as claimed in claim 1 further including:
an upper globe spaced from said lower globe, said upper globe securing said pair of side bow tubes, and further for slidably receiving an upper portion of said lower middle tube therethrough.

5. An apparatus, as claimed in claim 1, wherein:
said handle has at least a pair of extensions formed at corresponding corner edges of said handle, said extensions conforming to a curvature of said side bow tubes thereby securing said handle for slidable movement between said side bow tubes.

6. An apparatus, as claimed in claim 1, wherein:
said handle further includes means for engaging said pair of side bow tubes enabling slidable movement of said handle between said pair of side bow tubes and preventing said handle from being removed from said pair of side bow tubes.

7. An adjustable crutch comprising:
a pair of side bow tubes extending adjacent one another, said pair of side bow tubes each including an upper end and a lower end, and at least one opening formed through each of said side bow tubes adjacent said lower ends thereof;
a lower middle tube disposed between said lower ends of said pair of side bow tubes, said lower middle tube having a plurality of openings formed therethrough;
a lower globe for securing said lower ends of said side bow tubes and for slidably receiving said lower middle tube;
a handle disposed between said pair of side bow tubes adjacent said upper ends thereof; and
a projection formed in said lower globe and positioned for engagement with said openings formed in said lower middle tube as said lower middle tube is slid through said lower globe, said projection thereby registering a continuous aperture through said pair of side bow tubes and said lower middle tube at a location above said projection.

8. An apparatus, as claimed in claim 7, wherein:
said openings formed on said lower middle tube have depressions formed therearound thereby providing a transition between an exterior surface of the side bow tubes and the openings formed through the side bow tubes.

9. An apparatus, as claimed in claim 7, wherein:
said projection includes a pair of projections formed in said lower globe for engaging holes formed on opposite sides of said lower middle tube.

10. An apparatus, as claimed in claim 7, further including:
an upper globe spaced from said lower globe and securing said pair of side bow tubes and for slidable receiving an upper portion of said lower middle tube therebetween.

11. An apparatus, as claimed in claim 7, wherein:
said handle has at least a pair of extensions formed at corresponding corner edges of said handle, said extensions conforming to an exterior curvature of said side bow tubes thereby securing said handle for slidable movement between said side bow tubes.

12. An adjustable crutch comprising:
a pair of side bow tubes extending adjacent one another, said pair of side bow tubes each including an upper end and a lower end;
a lower middle tube disposed between said lower ends of said pair of side bow tubes;
a lower globe for securing said lower ends of said side bow tubes and for slidably receiving said lower middle tube therebetween; and
a handle disposed near said upper ends of said pair of side bow tubes and extending between said pair of side bow tubes, said handle further comprising at least a pair of extensions formed at corresponding corner edges of said handle, said extensions conforming to an exterior surfaces of said side bow tubes thereby facilitating slidable movement of said handle between said pair of side bow tubes, and preventing inadvertent removal of said handle between said pair of side bow tubes.

13. An adjustable crutch comprising:
a pair of side bow tubes extending adjacent one another, said pair of side bow tubes each including an upper end and a lower end, and a plurality of aligned transverse openings formed through each of said side bow tubes adjacent said upper ends thereof;
a lower middle tube disposed between said lower ends of said pair of side bow tubes;
a globe for securing said lower ends of said side bow tubes and for slidably receiving said lower middle tube; and
a handle disposed between said pair of side bow tubes adjacent said upper ends thereof, said handle being alignable with corresponding pairs of said plurality of transverse openings, said handle further including at least one projection formed on an end of said handle, said projection being engageable with one transverse opening of said plurality of transverse openings thereby registering a continuous aperture through said side bow tubes and said handle.

14. An apparatus, as claimed in claim 13, wherein:
said transverse openings include corresponding depressions formed therearound thereby providing a transition between an exterior surface of the side bow tubes and the transverse openings formed through the side bow tubes.

15. An apparatus, as claimed in claim 13, wherein:
said at least one projection includes a pair of projections, one projection formed at each end of said handle for engaging corresponding transverse holes on each side bow tube of said pair of side bow tubes.

16. An apparatus, as claimed in claim 13, wherein:
said handle further includes at least a pair of extensions formed at corresponding corner edges of said handle, said extensions conforming to an exterior curvature of said side bow tubes thereby securing said handle for slidable movement between said side bow tubes.
